(19) United States
(12) Patent Application Publication
(10) Pub. No.: US 2008/0177400 A1
(43) Pub. Date: Jul. 24, 2008

(54) FOOTWEAR OF COMMAND OUTPUT

(76) Inventor: Chuan-Tai Chiang, Taichung (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/686,126

(22) Filed: Mar. 14, 2007

(30) Foreign Application Priority Data
Jan. 23, 2007 (TW) 096102484

(51) Int. Cl. G05B 15/00

(52) U.S. Cl. 700/83

(57) ABSTRACT

The present invention relates to a kind of footwear with function of control command output. The footwear is equipped with at least two control buttons, one signal processing module and one signal transmission module. Users can put on the footwear and use their feet to press on the control keys such that reacting signals would be generated by the signal processing module, and then the command signals would be transmitted to computers or microcomputers control system via the signal transmission module, and in the end the computers or the microcomputers control system will execute the command and control programs. Users can use their feet to output control command by pressing on the footwear that they put on to operate computers or microcomputers control system conveniently.

### FIELD OF THE INVENTION

The present invention relates to a kind of footwear with function of control command output, and more particularly to a footwear that would be pressed by users to output control command. Users can use their feet to output control command by pressing on the footwear that they put on to operate computers or microcomputers control system conveniently.

### BACKGROUND OF THE INVENTION

It is commonly known that computers or microcomputers control system are nowadays popular electronic products that can assist people in doing their jobs, and to provide people varieties of entertainment and enjoyment such as controlling household electric appliances, playing audio/video or computer games, etc., which is to say an indispensable commodity in modern human lives.

As for the current computers or microcomputers control system, the operation systems need computer mice or digital panels to control and execute computer programs for users to operate conveniently. The current computer mice are commonly known of either a roller mouse as U.S. Pat. Nos. 4,623,787 and 5,696,537, or an optical mouse as U.S. Pat. Nos. 7,071,922 and 5,274,361, or a pen mouse as U.S. Pat. No. 7,030,864. Nevertheless, no matter what types of the commonly known mice as either a roller mouse or an optical mouse or a pen mouse, or a digital pen of a digital panel, which are for hand operation in design. Trying to operate a computer mouse by foot, one will find foot is unable to efficiently manage operation of the computer mouse, nor easily press on the mouse control buttons, which is extremely inconvenient in use. Likewise, the commonly known pen mouse or digital pen would also have a lot of trouble in operation when human feet is used to operate. That is to say, the way to operate commonly used computers or microcomputers control system is totally not suitable for armless people or those who have problem to use their hands, which is unfair for them.

Noted that the current commonly used computers or microcomputers control system have trouble for feet operation, no way for armless people or those who have problem to use their hands to operate computers conveniently as enjoyable as normal people, the inventor of this invention decided to dedicate into research and development, with plenty of research and tests, this invention that has real efficiency is finally developed.

### SUMMARY OF THE INVENTION

The primary objective of the present invention is to provide a kind of footwear with function of control command output that handicapped people who have no arm or problem of using their hands could use the footwear that they are wearing to operate and control computers or microcomputers control system. The practical measure of technique is that the footwear is equipped with at least two control buttons, a signal processing module and a signal transmission module. Users can put on the footwear and use their feet to press on the control buttons such that reacting signals would be generated by the signal processing module, and then the command signals would be transmitted to computers or microcomputers control system via the signal transmission module, and in the end the computers or the microcomputers control system will execute the command and control programs.

The second objective of the present invention is to provide a kind of footwear with function of computer mouse that handicapped people who have no arm or problem of using their hands can use the footwear to manipulate programs installed in computers. The practical measure of technique is that the footwear is equipped with a signal processing module, a signal transmission module, two control buttons and a roller. The two control buttons consist of a right control button that has functions same as the right control button of a computer mouse and a left control button that has functions same as the left control button of a computer mouse, and are electrically connected with the signal processing module to enable the signal processing module to generate signals of function of a right control button and a left control button of a computer mouse. The roller is pivotally installed at front of the footwear, which to enable the signal processing module to generate signals of scrolling function of a computer mouse. The signal transmission module is electrically connected with the signal processing module to transmit the generated signals from signal processing module to a computer.

The present invention will become more obvious from the following description when taken in connection with the accompanying drawings that show, for purposes of illustration only, a preferred embodiment in accordance with the present invention.

### BRIEF DESCRIPTION OF THE DRAWINGS

FIG. 1 is a plan view of the basic embodiment of the present invention;

FIG. 2 is a perspective view of the footwear of the present invention;

FIG. 3 is a plan view of wireless signal transmission module of the present invention;

FIG. 4 is a plan view of the cursor control module of the present invention;

FIG. 5 is a cross-sectional view of the first embodiment of the cursor control module of the present invention;

FIG. 6 is a cross-sectional view of the second embodiment of the cursor control module of the present invention;

FIG. 7 is a plan view of the roller of the present invention;

FIG. 8 is a perspective view of the digital panel of the present invention;

FIG. 9 is a cross-sectional view of the power device of the present invention; and

FIG. 10 is a perspective view of the light emitting diode of the present invention.

### DETAILED DESCRIPTION OF THE PREFERRED EMBODIMENT

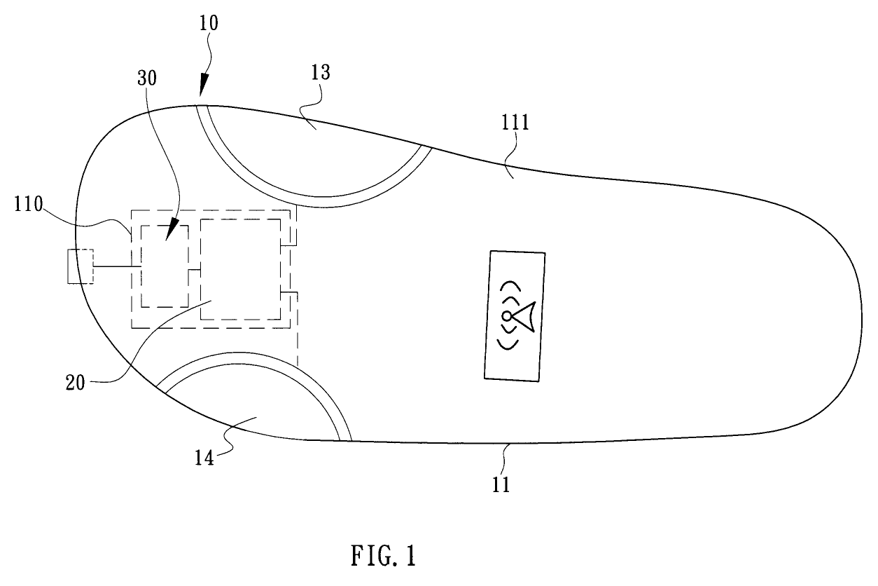

The present invention is basically focused on design and development in having footwear to be equipped with function of control command signal output such that handicapped people who have no arm or problem of using their hands can use the footwear that they are wearing to operate and control computers or microcomputers control system. Referring to FIG. 1, the basic technical feature of the present invention is that a footwear 10 is equipped with at least two control buttons 13 and 14, a signal processing module 20 and a signal transmission module 30. Users can put on the footwear and use their feet to press on the control buttons 13, 14 such that reacting signals would be generated by the signal processing module 20, and then the command signals would be transmitted to computers or microcomputers control system via the signal transmission module 30, and in the end the computers or the microcomputers control system will execute the command and control programs.

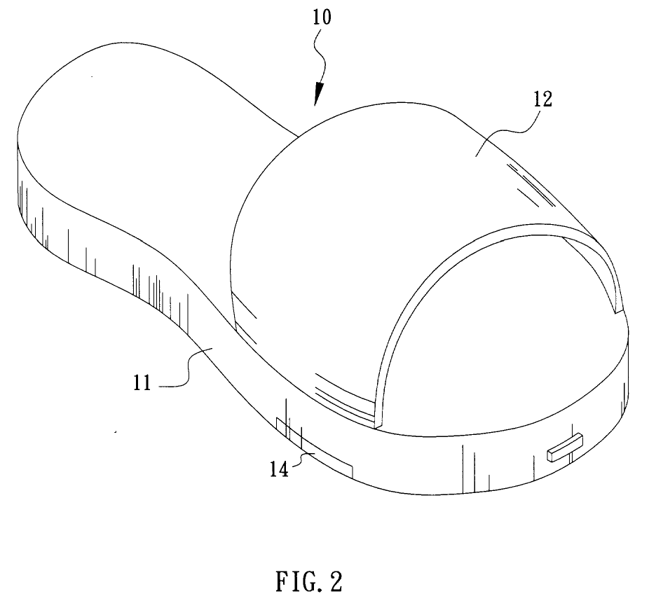

Referring to FIG. 2, the footwear 10 of the present invention is composed of a main body and a constraint band connected to the main body. The main body is attached to a user's foot downside and adhered to the user's foot with help of the constraint band. The embodiment shown in the figure is that the footwear 10 is an indoor shoe that has the sole 11 being the main body of the footwear 10, and the vamp 12 on top of the sole 11 being the constraint band on top side of the main body. The vamp 12 can be a strip that makes the footwear an indoor slipper. Slippers are for home living, which are often used and easy to be put on, especially suitable for operating computers or microcomputers control system.

Referring to FIG. 1, an embodiment of the present invention uses a shoe 10 as an example for explanation, the shoe 10 comprises a shoe sole 11, a signal processing module 20, at least two control buttons 13, 14 and a signal transmission module 30. The shoe sole 11 includes a compartment 110, a bottom side, an upper side that is opposite to the bottom side, and a vamp 12 that is connected to the upper side. The signal processing module 20 is disposed inside the compartment 110 and is for processing the input control signals and for signals output. The at least two control buttons 13, 14 are installed on the bottom side 111 of the sole 11 for taking reacting forces coming from other objects, which are composed of a right control button 13 and a left control button 14 and electrically connected with the signal processing module 20 to enable the signal processing module 20 to generate signals of command function of control buttons. The signal transmission module 30 is connected electrically with the signal processing module 20, which transmits signals output from the signal processing module 20 to a central processing unit of a computer. Furthermore, for ease of taking out and putting in whole set of modules, a case can be added to the main body of the footwear 10 that would be used to accommodate the signal processing module 20 and the signal transmission module 30, the case is disposed inside the compartment 110 of the main body.

With the use of the design in the present invention, a user puts on the shoe 10 and uses his/her foot to press on the portion of the right control button 13 or the left control button 14 on the bottom side of the shoe 10, such that the right control button 13 or the left control button 14 would generate corresponding signals and then transmit the signals to the signal processing module 20, and then the signal processing module 20 would generate corresponding signals output to the signal transmission module 30, from which signals would be transmitted to the programs of computers or microcomputers control system for corresponding controls.

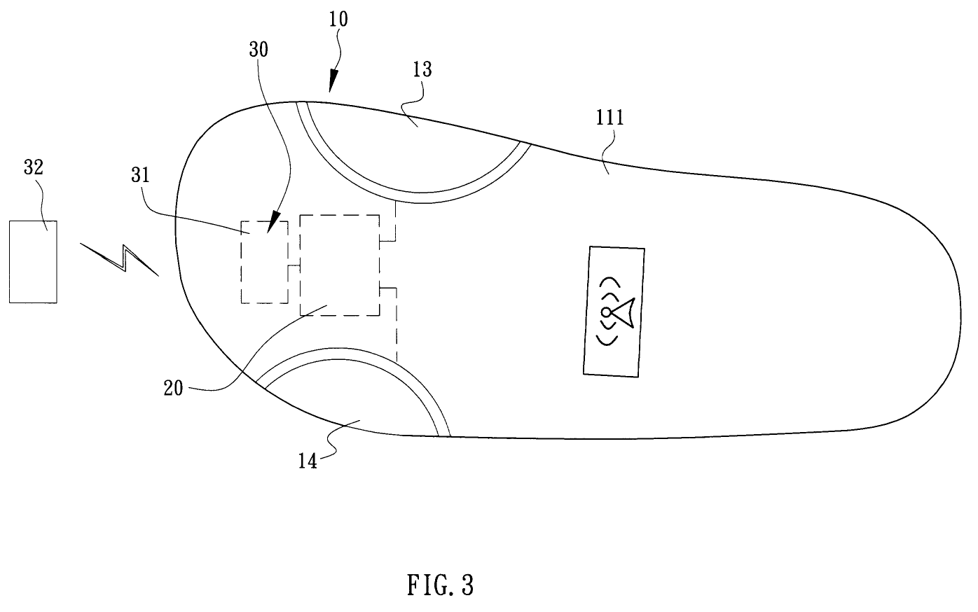

Referring to FIG. 3, a preferred embodiment of the present invention, the signal transmission module 30 may be a wireless signal transmission module that includes a wireless emission element 31 installed on the sole 11 and an independent wireless receiving element 32. Furthermore, the wireless signal transmission module may be a wireless Bluetooth transmission module for transmission of digital signals.

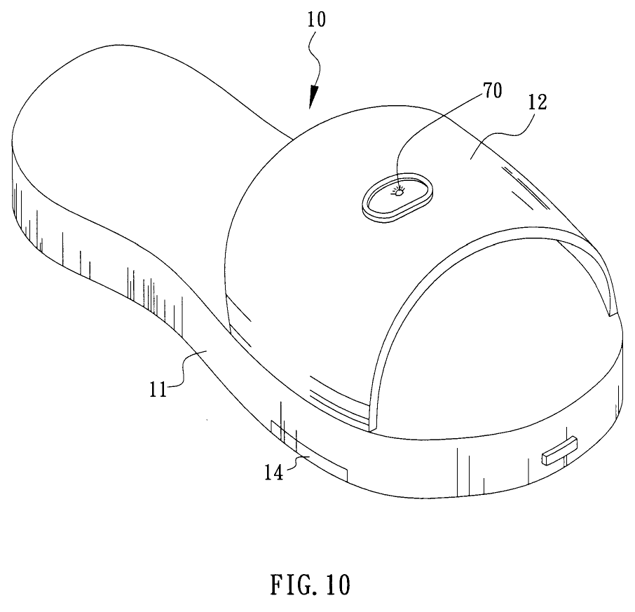

Referring to FIG. 1 and 10, another preferred embodiment of the present invention, a light emitting diode 70 is added on the footwear 10 and is electrically connected with the signal processing module 20. When the signal processing module 20 is working on signal processing, it will activate the light emitting diode 70 to radiate light. The light emitting diode 70 is installed on the vamp 12 of the footwear 10 such that aesthetic feeling would be increased and the light emitting diode 70 can be easily visualized and checked for operation status of the signal processing module 20.

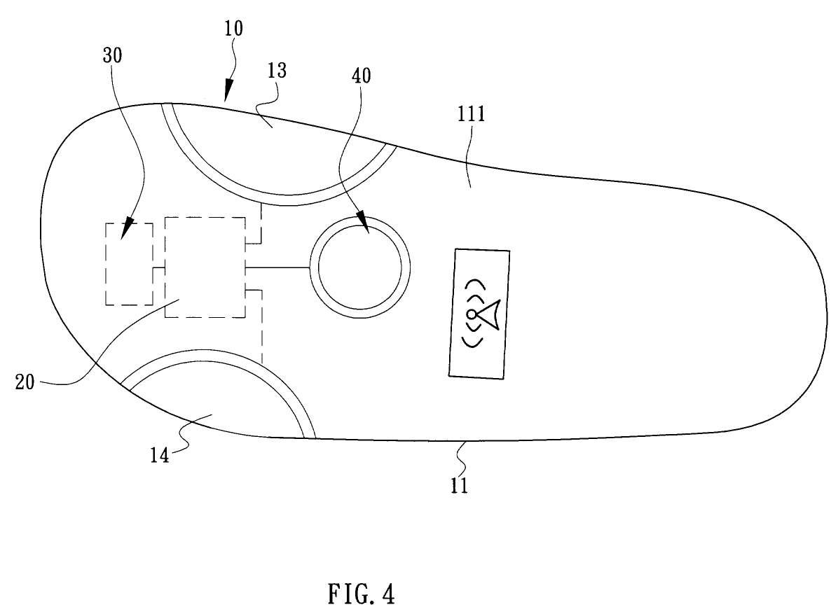

Referring to FIG. 4, in addition to the aforementioned mechanism, the present invention may have a cursor control module 40 that is installed on the bottom side 111 of the sole 11 and electrically connected with the signal processing module 20, such that when the sole 11 is moving relatively to a surface, the cursor on a computer monitor would be moved correspondingly. The cursor control module 40 combines with the right control button 13 and the left control button 14 to have functions of a computer mouse.

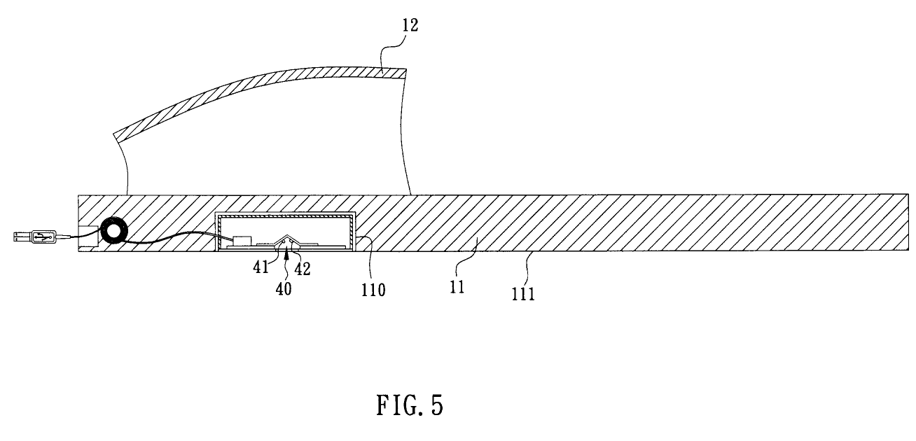

Referring to FIG. 5, a well known technique can be applied to the cursor control module 40 of the present invention, which includes a light emission element 41 and a light receiving element 42. The light emission element 41 emits light beams out from the bottom side 111 of the sole 11 onto the surfaces of other objects, and then from the surface the light reflects to be received by the light receiving element 42 and thereof generates a signal read by the signal processing module 20 to decide the location where the cursor should be on the monitor of the computer, which is so called the cursor control technique of an optical mouse.

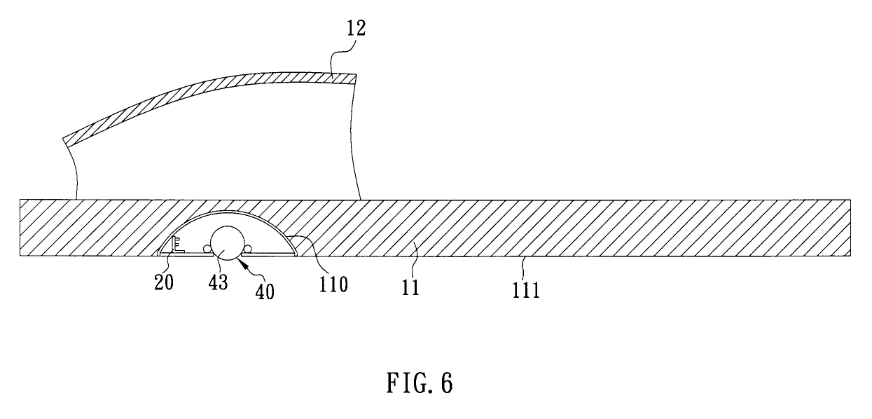

Referring to FIG. 6, a well known technique can be applied to the cursor control module 40 of the present invention, which includes a roller ball 43 and a ball rolling signals generation mechanism (not shown in the figure, as a well known technique). The ball rolling signals generation mechanism can detect the rolling status of the roller ball 43 and generate a signal read by the signal processing module 20 to decide the location where the cursor should be on the monitor of the computer.

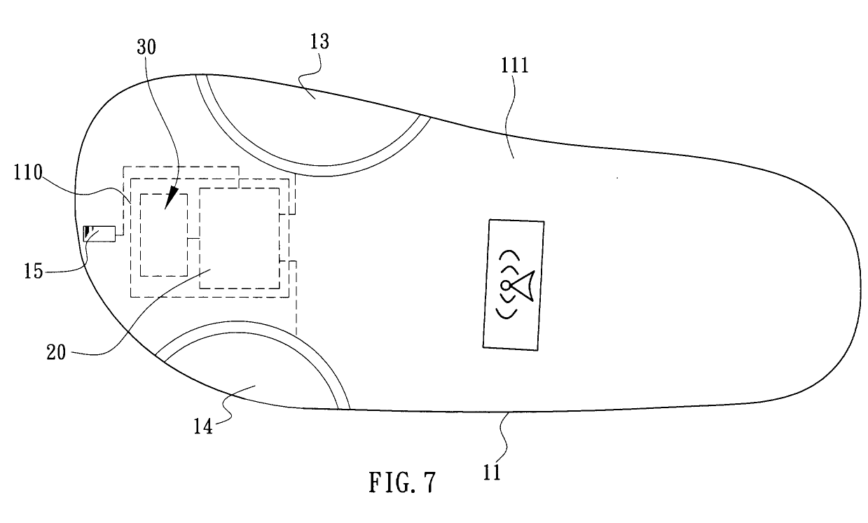

Referring to FIG. 7, in addition to the right control button 13 and the left control button 14, the present invention may have a roller 15 installed at front side of the sole 11. The left control button 14 and the right control button 13 are installed on bottom side 111 of the sole 11 for taking reacting forces coming from other objects. The right control button 13 would generate functions of a right control button of a computer mouse, and the left control button 14 would generate functions of a left control button of a computer mouse, which both are connected electrically with the signal processing module 20 to enable the signal processing module 20 to generate signals of function of right and left control buttons of a computer mouse. The roller 15 is pivotally installed at front side of the sole 11 for the signal processing module 20 to enable the signal processing module 20 to generate signals of scrolling function of a computer mouse.

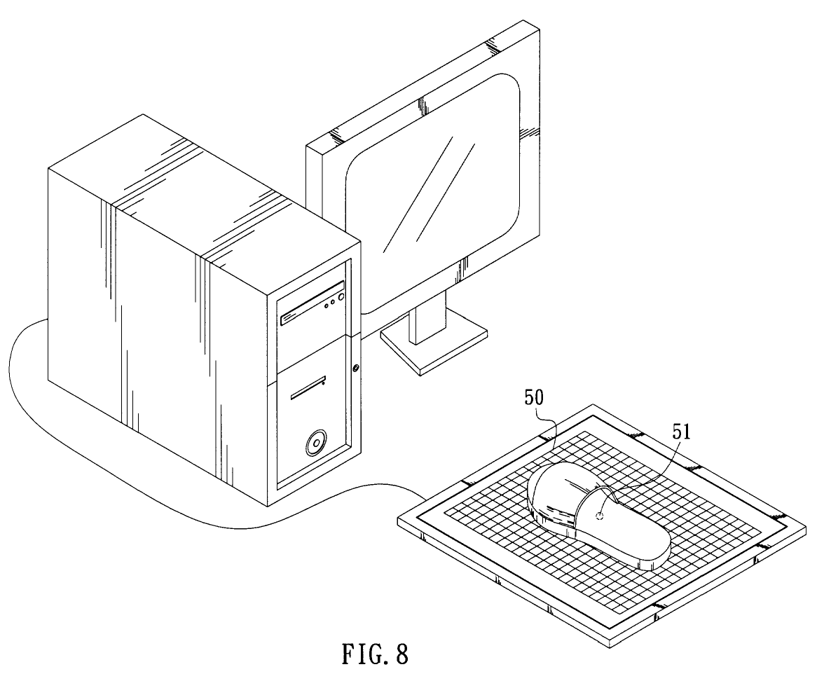

Referring to FIG. 4 and 8, a well known technique can be applied to the cursor control module 40 of the present invention, which includes a passive sensor element 51 installed on the sole 11 of the shoe 10 and a digital panel 50 that would generate sensed signals correspondingly with the passive sensor element 51. When the passive sensor element 51 is moving together with the sole 11 on the digital plane 50, the digital panel 50 would generate sensed signals read by the signal processing module 20 to decide the location where the cursor should be on the monitor of the computer.

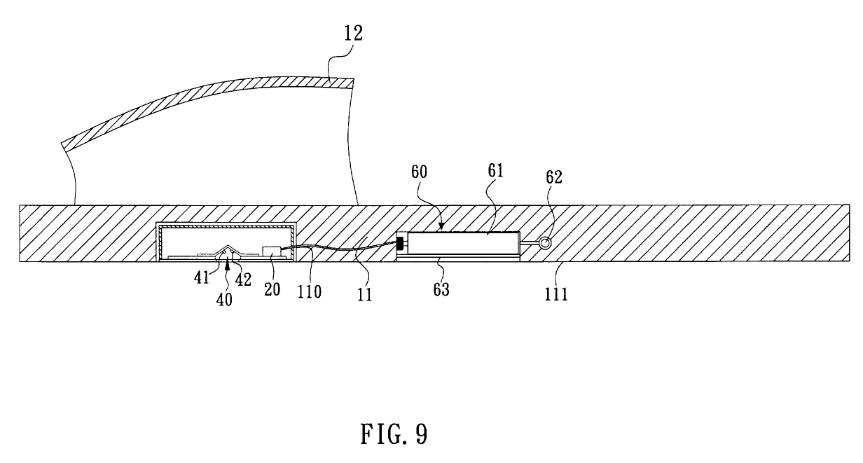

In addition to a power source that provides electricity, the present invention may be designed to having battery power provision. Referring to FIG. 9, basically a power device 60 is installed in the shoe 10, the power device 60 may be integrated with the sole 11 and connected electrically with the signal processing module 20 for provision of required electricity.

Furthermore, for giving the shoe 10 with more convenience in using, the present invention may be designed to having rechargeable battery power provision. The embodiment is that the power device 60 includes at least a battery 61, a charging circuit 63 and a charging terminal 62. The charging terminal 62 has one side electrically connected with the charging circuit 63 and the other end is provided for being connected with a power source, such that the power source will charge power to the battery.

While we have shown and described the embodiment in accordance with the present invention, it should be clear to those skilled in the art that further embodiments may be made without departing from the scope of the present invention.

What is claimed is:

1. A footwear with function of control command output comprising:
a main body attached to a user's feet downside including a compartment, a bottom side, an upper side opposite to the bottom side, and a constraint band connected to the upper side for mounting on the user's feet;
a signal processing module accommodated in the compartment for processing input control signals and for signals output;
at least two control buttons installed on the main body for taking reacting forces coming from an object, which including a right control button and a left control button and electrically connected with the signal processing module to enable the signal processing module to generate signals of command control function; and
a signal transmission module connected electrically with the signal processing module, which transmitting signals output from the signal processing module to a central processing units of a computer.

2. The footwear as claimed in claim 1, wherein the signal transmission module is a wireless signal transmission module including a wireless emission element and a wireless receiving element.

3. The footwear as claimed in claim 2, wherein the wireless signal transmission module is a wireless Bluetooth transmission module.

4. The footwear as claimed in claim 1, wherein the footwear further comprises a cursor control module that is installed on the bottom side of the main body and electrically connected to the signal processing module, such that when the main body being moving relatively to a surface, a cursor on a computer monitor would be moved correspondingly, the cursor control module combining with the right control button and the left control button to have functions of a computer mouse.

5. The footwear as claimed in claim 4, wherein the cursor control module includes a light emission element and a light receiving element, the light emission element emitting light beams out from the bottom side of the main body onto the surface, and then from the surface the light reflected to be received by the light receiving element and thereof generating a signal read by the signal processing module to decide a location where the cursor should be on the computer monitor.

6. The footwear as claimed in claim 4, wherein the cursor control module includes a roller ball and a ball rolling signals generation mechanism, the ball rolling signals generation mechanism being able to detect status of rolling of the roller ball on the surface and generating a signal read by the signal processing module to decide a location where the cursor should be on the computer monitor.

7. The footwear as claimed in claim 1, wherein the footwear further comprises a power device for providing required electricity of the signal processing module.

8. The footwear as claimed in claim 1, wherein the footwear further comprises a power device for providing required electricity of the signal processing module, the power device including a battery and a charging terminal, one end of the charging terminal electrically connected with the battery and the other end for connecting with a power source, the power source being able to charge power to the battery.

9. The footwear as claimed in claim 1, wherein the right control button and the left control button are disposed on the bottom side of the main body.

10. The footwear as claimed in claim 1, wherein the footwear is an indoor shoe, the main body is a sole of the shoe and the constraint band is a vamp of the shoe.

11. The footwear as claimed in claim 10, wherein the constraint band is a strip that makes the shoe an indoor slipper.

12. The footwear as claimed in claim 1, wherein a light emitting diode is added on the footwear and electrically connected to the signal processing module, when the signal processing module working on signal processing, which activating the light emitting diode to radiate light.

13. The footwear as claimed in claim 12, wherein the light emitting diode is installed on the constraint band of the footwear.

14. The footwear as claimed in claim 1, wherein the main body is equipped with a roller for the signal processing module to enable the signal processing module to generate signals of scrolling function of a computer mouse.

15. The footwear as claimed in claim 14, wherein the roller is installed at front side of the main body.

16. The footwear as claimed in claim 1, wherein the footwear further comprises a case for accommodating the signal processing module and the signal transmission module, the case being disposed inside the compartment.

17. A footwear with function of control command output comprising:
a main body attached to a user's foot downside including a compartment, a bottom side, an upper side opposite to the bottom side, and a constraint band connected to the upper side for mounting on the user's foot;
a signal processing module accommodated in the compartment for processing input control signals and for signals output;
at least two control buttons installed on the bottom side of the main body for taking reacting forces coming from an object, which including a right control button and a left control button and electrically connected with the signal processing module to enable the signal processing module to generate signals of command control function; and
a wireless signal transmission module including a wireless emission element and connected electrically with the signal processing module, which transmitting signals output from the signal processing module to a receiving element connected electrically with a computer.

18. The footwear as claimed in claim 17, wherein the wireless signal transmission module is a wireless Bluetooth transmission module.

19. The footwear as claimed in claim 17, wherein the footwear further comprises a cursor control module that is installed on the bottom side of the main body and electrically connected to the signal processing module, such that when the main body being moving relatively to a surface, a cursor on a computer monitor would be moved correspondingly, the cursor control module combining with the right control button and the left control button to have functions of a computer mouse.

20. The footwear as claimed in claim 19, wherein the cursor control module includes a light emission element and a light receiving element, the light emission element emitting light beams out from the bottom side of the main body onto the surface, and then from the surface the light reflected to be received by the light receiving element and thereof generating a signal read by the signal processing module to decide a location where the cursor should be on the computer monitor.

21. The footwear as claimed in claim 19, wherein the cursor control module includes a roller ball and a ball rolling signals generation mechanism, the ball rolling signals generation mechanism being able to detect rolling status of the roller ball on the surface and generating a signal read by the signal processing module to decide a location where the cursor should be on the computer monitor.

22. The footwear as claimed in claim 17, wherein the footwear further comprises a power device for providing required electricity of the signal processing module.

23. The footwear as claimed in claim 17, wherein the footwear further comprises a power device for providing required electricity of the signal processing module, the power device including a battery and a charging terminal, one end of the charging terminal electrically connected with the battery and the other end for connecting with a power source, the power source being able to charge power to the battery.

24. The footwear as claimed in claim 17, wherein a light emitting diode is added on the footwear and electrically connected to the signal processing module, when the signal processing module working on signal processing, which activating the light emitting diode to radiate light.

25. The footwear as claimed in claim 24, wherein the light emitting diode is installed on the constraint band of the footwear.

26. The footwear as claimed in claim 17, wherein the main body is equipped with a roller for the signal processing module to enable the signal processing module to enable the signal processing module to generate signals of scrolling function of a computer mouse.

27. The footwear as claimed in claim 17, wherein the footwear is an indoor shoe, the main body of the footwear being a shoe sole and the constraint band being a vamp of the sole.

28. The footwear as claimed in claim 27, wherein the vamp is a strip that makes the footwear an indoor slipper.
